(19) United States
(12) Patent Application Publication
(10) Pub. No.: US 2011/0231775 A1
(43) Pub. Date: Sep. 22, 2011

(54) SYSTEM, METHOD AND COMPUTER-READABLE MEDIUM FOR MANAGING SOFTWARE SERVICE ACCESS VIA TOOLBAR USER MANAGEMENT

(75) Inventors: Adele Goldberg, Columbia Falls, MT (US); J. Andrew Freeman, San Jose, CA (US)

(73) Assignee: Vertro, Inc., New York, NY (US)

(21) Appl. No.: 13/053,831

(22) Filed: Mar. 22, 2011

Related U.S. Application Data
(60) Provisional application No. 61/340,653, filed on Mar. 22, 2010.

(51) Int. Cl. G06F 3/048

(52) U.S. Cl. 715/738

(57) ABSTRACT

Exemplary embodiments of the present disclosure can provide a computer-based application stored on a non-transitory computer-readable medium including instructions thereon that are accessible by a hardware processing arrangement. When the processing arrangement executes the instructions, the processing arrangement can be configured to provide a graphical user interface to at least one user, the graphical user interface providing for collection of user registration data, provide at least a portion of the registration data to at least one service provider application, access at least one data store including data associated with the at least one user, receive an alert associated with at least one service provider application pushed to the at least one user, and receive a response from the at least one user associated with the alert.

### CROSS-REFERENCE TO PRIOR APPLICATIONS

This application claims priority to U.S. Provisional Application Ser. No. 61/340,653, filed on Mar. 22, 2010, the disclosure of which is incorporated by reference herein in its entirety.

### FIELD OF THE DISCLOSURE

The present disclosure relates to exemplary systems, methods, and computer-readable medium for delivering goods and/or services, and in particular to exemplary applications for facilitating access to software services.

### BACKGROUND INFORMATION

Computer program systems have been developed to perform and facilitate many tasks. For example, computer programs to facilitate the collection and analysis of research data have been developed, and some such computer program systems are commercially available. Some commercially available computer program systems can facilitate conducting surveys, including questionnaires, opinion polls, or the like. Such commercially available computer program systems can be well suited for conducting such surveys by using a variety of communications formats, devices, media, and protocols. For example, the medium for delivering such surveys can include, but is not limited to, Internet websites, email, computers, computers with wireless and/or wired network connections, personal digital assistants, cell phones, and so on. Such commercially available computer program systems can be well suited for delivering notice of surveys or actual surveys through email systems.

Additionally, computer program systems to facilitate the collection and analysis of educational data have also been developed, and some such computer program systems are commercially available. Such commercially available computer program systems can facilitate conducting assessments of knowledge and skills, where such assessments take the form, for example, of sets of questions of various types, interactive games, or tests of physical dexterity. Question types can include, for example, multiple choice, fill-in-the-blank, text comment, ranking a set of items, rating items on given scales, and allocating preferences to a set of items. Such commercially available computer program systems can be well suited for conducting such assessments by using a variety of communications formats, devices, media, and protocols. For example, the medium for delivering such assessments can include, but is not limited to, Internet websites, email, computers, computers with wireless and/or wired network connections, personal digital assistants, cell phones, and so on. Such commercially available computer program systems are well suited for delivering notice of assessment and the actual assessments through email systems.

Other computer program systems to provide user access to software services have also been developed, which include, for example, registering users, maintaining data about the users, and maintaining data about user participation in the software services. Some such computer program systems are commercially available. Such commercially available computer program processes and systems can facilitate, for example, managing project tasks, managing document files, managing electronic mail, managing contacts including managing relationships with contacts. Such commercially available computer program systems can be well suited for access via computer websites, and such websites are sometimes referred to as customer portals.

Some conventional processes and systems for providing software services rely on the use of computer memory storage for storing data, either on the end user's local computer system or the service providers own systems.

Some conventional processes and systems for providing software services, such as surveys and assessments, facilitate service access involving a few participants or a few participants at a time. Other conventional processes and systems are able to invite or recruit dozens, hundreds, or thousands of potential participants and to conduct surveys or assessments involving dozens, hundreds, or thousands of recruited participants. Some commercial methods and systems for conducting surveys or assessments provide participant management features for inviting, recruiting, or involving large numbers of participants in surveys using conventional or offline display advertisement in magazines or newspapers or non-electronic mail, email, website advertisement, or wireless device alerts.

Computer program systems that create downloadable toolbars for browsers have also been developed. A browser is typically a computer program that displays information from a multiplicity of sources and offers a multiplicity of widgets. Toolbars may also be presented on a computer screen outside the use of a browser (also referred to as the computer desktop). A toolbar can be a widget on which, for example, onscreen buttons, icons, menus, or other input or output elements are placed. A widget can be a screen interface that links the user to an executable application. Some widgets are textual, some are graphical. Many modern programs and operating systems allow the end user to modify and customize toolbars to fit their personal needs. Such customization is often facilitated, for example, by access to libraries of buttons, icons, menus, or other input and output elements. Browser toolbars can provide helpful and useful functionality such as search fields, form-fill, links back to popular sites, links to applications that open in separate windows. Some toolbar elements can provide continuous viewing of data, such as sport scores, stock prices, weather reports, news alerts, and word challenges. Toolbars implemented as web browser plug-ins can be used for advertising major brands by use of brand logos, branded search fields, and links to branded websites such as for retail purchases, newscasts, weather stations, and online video sites. A plug-in (also called plugin, addin, add-in, addon, add-on, snap-in, snapin, or extension) can include a computer program that interacts with a host application (a web browser or an email client, for example) to provide a certain, usually very specific, function on demand.

Computer program systems have also been developed that create a homepage (or home page or start page), which is typically the URL (Uniform Resource Locator, which can refer to a local file or content stored at a remote site) that automatically loads when a web browser starts or when the browser's “home” button is pressed. The web browser user can turn this feature off and on, as well as specify a URI (Uniform Resource Indicator) as the page to be loaded when the web browser starts. A homepage can be a website page that is meant to organize links or information, including for example aggregating information such as RSS (Really Simple Syndication) feeds.

Many commercial providers of toolbars provide homepages that present links to such services as libraries of new buttons, menus, icons, or other input or output elements, often including widgets which are small applications or programs that can be displayed and made available for use in a web browser page. A homepage can be customizable by selecting from a library of services or widgets. The contents of a homepage are not necessarily the same as that of the corresponding toolbar.

### SUMMARY OF EXEMPLARY EMBODIMENTS

Exemplary embodiments of the present disclosure can provide exemplary processes and systems to support the delivery of goods and/or services using, for example, computer browser toolbars and homepages. According to an aspect of the disclosure, the exemplary system can associate the registration of toolbar users and/or homepage users with the users participating in an organization's services, where such services may involve the taking of surveys or assessments. For example, each user associated via the toolbar or homepage to the service can be notified that the user's participation in some aspect of the organization's service is requested, anticipated, or required. Notification can be, for example, via a button, icon, menu, or other input or output element of the toolbar or homepage, including a widget residing on that homepage. The notification can occur a multiplicity of times over the time that the toolbar or homepage can be accessed by the user.

Exemplary embodiments of the present disclosure can also provide combinations of delivering the service to the user upon clicking on a toolbar or homepage element, recording whether the user has completed the service, permitting the user to re-engage in the use of the service so as to modify any actions taken, tracking the user's use of the Internet including visiting other websites in order to add this data to the organization's own user participation data, tracking the user's use of non-Internet applications, and sending user participation information to the same or another organization, for example, an organization responsible for providing rewards.

Exemplary embodiments of the present disclosure can also provide for the ability to link a toolbar or homepage user to multiple such software services.

An exemplary embodiment of the present disclosure can provide a computer-based application stored on a non-transitory computer-readable medium including instructions thereon that are accessible by a hardware processing arrangement. Further, when the processing arrangement executes the instructions, the processing arrangement can be configured to provide a graphical user interface to at least one user, the graphical user interface providing for collection of user registration data, provide at least a portion of the registration data to at least one service provider application, access at least one data store including data associated with the user(s), receive an alert associated with the service provider application(s) pushed to the user(s), and receive a response from the user(s) associated with the alert. The graphical user interface can include a toolbar and can be a front-end user interface for the service provider application(s). Additionally, the graphical user interface can be configured to update the data store to include the collected data, and the data can include at least one of a tracking history, previous responses to alerts, demographic information, or response data associated with the service provider application(s).

Further, the service provider application(s) or the user interface can be further configured to collect data associated with the user(s), and the user interface can be configured to facilitate a registration of the user(s) with at least one of the computer-based application or the service provider application(s) using the registration data.

The service provider application(s) can include at least one of a survey, a promotion, a product offer, a coupon, a poll, or a service being made available to the user(s), and the service provider application(s) can include a plurality of service provider applications associated with a plurality of providers. Further, the user interface can be configured to facilitate a participation in the service provider application(s). Participation can include at least one of taking a survey, responding to a poll, accepting an offer, or agreeing to a promotion

According to an exemplary embodiment of the present disclosure, the user interface can be configured to selectively push the alert based on at least a portion of the data associated with the user(s). The data can include at least one of a tracking history, previous responses to alerts, demographic information, or survey response data, and the selective pushing includes selectively determining the alert to be pushed

According to another exemplary embodiment of the present disclosure, a system for facilitating access to at least one service provider application can be provided. The system can include a hardware processing arrangement and instructions stored on a non-transitory computer-readable medium that are accessible by the hardware processing arrangement. When the processing arrangement executes the instructions, the processing arrangement can be configured to provide a graphical user interface to at least one user, the graphical user interface providing for collection of user registration data; provide at least a portion of the registration data to the service provider application(s), access at least one data store including data associated with the user(s), receive an alert associated with service provider application(s) pushed to user(s), and receive a response from user(s) associated with the alert.

The user interface can include a toolbar and can be a front-end user interface for the service provider application(s). The service provider application(s) can include at least one of a survey, a promotion, a product offer, a coupon, a poll, or a service being made available to the user(s), and the user interface can be configured to selectively push the alert based on at least a portion of the data associated with the user(s).

According to another exemplary embodiment of the present disclosure, method can be provided for facilitating access to at least one service provider application. The exemplary method can include providing, using a computing arrangement, a graphical user interface to at least one user, the graphical user interface providing for collection user registration data, providing at least a portion of the registration data to the service provider application(s) via at least one network connection, accessing at least one data store including data associated with the user(s) via the network connection(s), receiving an alert associated with the service provider application(s) pushed to the user(s) via the computing arrangement, and receiving, using the computing arrangement, a response from the user(s) associated with the alert.

The user interface can include a toolbar and can be a front-end user interface for the service provider application(s). The service provider application(s) can include at least one of a survey, a promotion, a product offer, a coupon, a poll, or a service being made available to the user(s), and the user interface can be configured to selectively push the alert based on at least a portion of the data associated with the user(s).

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary flow diagram of an exemplary interface between a toolbar and a survey service according to an embodiment of the present disclosure;

FIG. 2 is an exemplary flow diagram of an exemplary interface between a toolbar and a survey service according to an embodiment of the present disclosure;

FIG. 3 is an exemplary flow diagram of an exemplary interface between a toolbar and a survey service according to an embodiment of the present disclosure;

FIG. 4 is an exemplary flow diagram of an exemplary interface between a toolbar and a survey service according to an embodiment of the present disclosure;

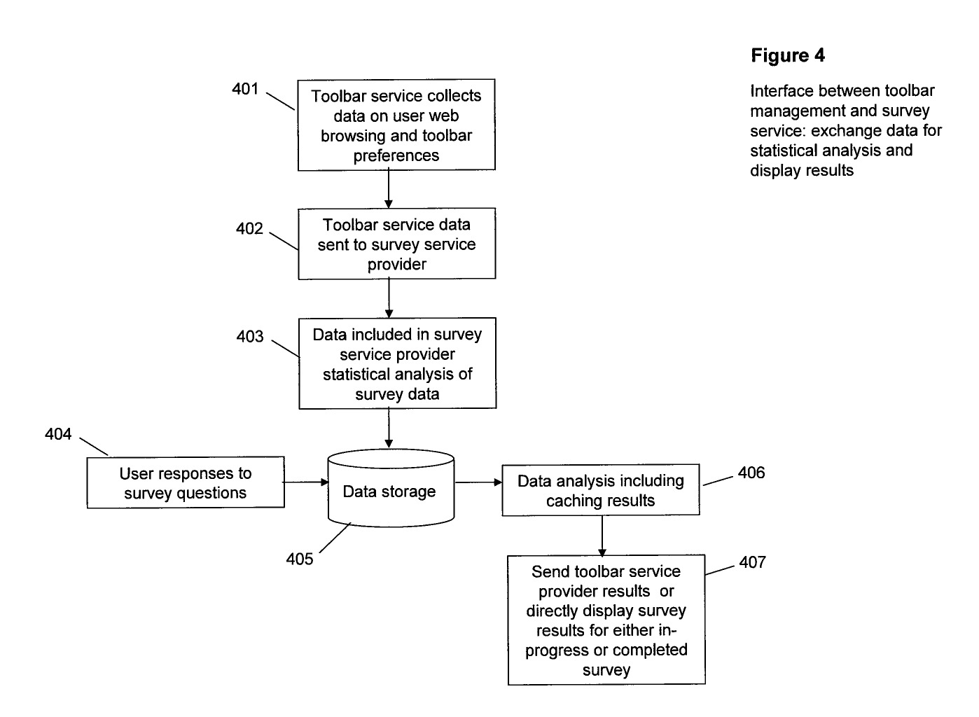

FIG. 5 is an exemplary flow diagram of an exemplary interface between a toolbar and a survey service according to an embodiment of the present disclosure;

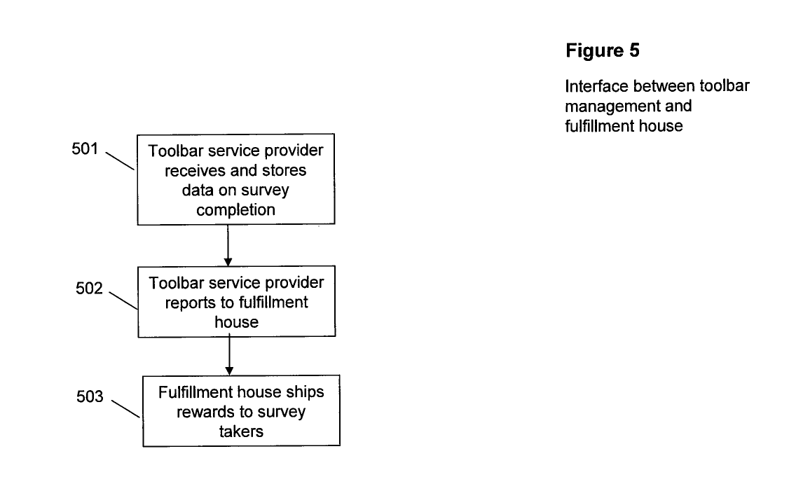

FIG. 6 is an illustration of an exemplary context of systems and processes in which toolbars and survey services can be implemented according to an embodiment of the present disclosure; and

FIG. 7 is an exemplary block diagram of an exemplary embodiment of a system according to the present disclosure.

### DETAILED DESCRIPTION OF EXEMPLARY EMBODIMENTS

Toolbar and homepage providers can realize return on their investment in maintaining the processes and software services that create a multiplicity of toolbars and homepages, and advertising or otherwise obtaining users of the toolbars and homepages, in a variety of ways. Typical revenue sources can include, for example: (1) payment for the use of the toolbar or homepage for advertising goods and services, where either the content of the toolbar or homepage is an advertisement for which the advertiser pays for the use of the screen space or the content is a button or other input or output element that links the user to said advertisement; or (2) payment for placing a button, menu, icon, or other input or output element on the toolbar or homepage, whose persistent presence at the top of the web browser or on the homepage advertises the goods or services of an organization.

The addition of the ability to provide exemplary embodiments of the present disclosure enables additional sources of revenue, for example: (a) payment by an organization to use the toolbar or homepage screen space to alert users on surveys, assessments, or other services for which the user could receive goods from the organization as a reward for participation in the service; (b) payment by an organization wishing to benefit from the use of the screen space of a toolbar or homepage in order to give access to users to a service, such as a survey or assessment; or (c) payment by an organization on a per user basis as recognition that the user has participated in said service.

Exemplary embodiments of the present disclosure can provide a smart application, such as a toolbar, that can provide: (a) coordinating user registration with a toolbar or homepage, with registration to participate in a service, such as a survey; (b) notifying users of availability of a service from one of a possible multiplicity of service providers; (c) giving users access to one of a possible multiplicity of services; (d) giving users access to return to modify input (responses) in using one of a possible multiplicity of services; (e) possibly giving users access to data about results immediately after completing a service or offering; (f) giving users access to data about results once the service is completed (also called closed); and (g) providing additional user website browsing tracking data to a service provider to be used as additional demographic information in providing statistical or other reports. Although exemplary embodiments of the present disclosure are described with respect to survey services, other offers and services are contemplated. For example, the provider services can include promotions, discounts, coupons, surveys, polls, educational assessments, and the like.

In an exemplary embodiment, the toolbar of the present disclosure provides a user-interface front end for various service provider applications, typically a component of a graphical user interface (“GUI”), e.g., a graphical presentation representing the application. Preferably, service provider applications can have access to information, which can also be accessed by the toolbar, so that the toolbar is a “smart” toolbar, processing this information and facilitating the above-described interactions based on the processing of the information. Accordingly, the toolbar can target specific services to users based on information, e.g., demographics, likes, dislikes, interests, location, past service participation, about the user that it ascertains from the information.

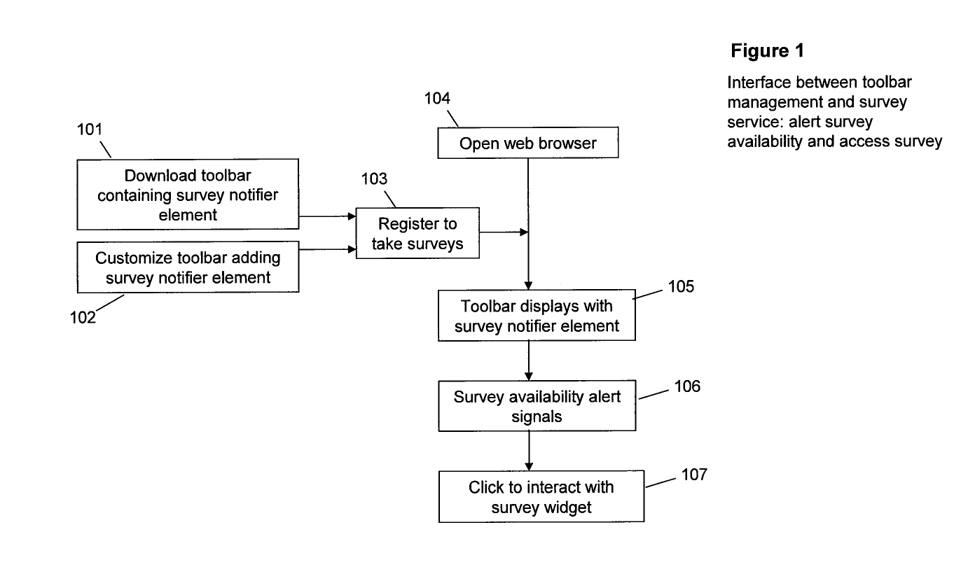

In an embodiment of the present disclosure, a toolbar application can be provided to facilitate delivery and processing of service provider applications to users. For example, as shown in FIG. 1, an organization can advertise the availability of and can make available a toolbar that can include a survey element that links the toolbar user to taking one or a multiplicity of surveys, over the course of one session or many sessions held over days, weeks, months, or years (101). The organization can also advertise and make available a survey element independent of any particular toolbar, and provide a means by which the user can add the survey element to an existing toolbar (102). The toolbar provider can provide a multiplicity of such survey elements, each focused on one or a multiplicity of survey providers. The survey provider could, for example, be an organization carrying out focus groups about its products, such as a consumer products company; an organization looking to understand public opinion, such as a government organization; or an organization looking to learn more about people's interests and preferences, such as a public relations or marketing specialty company.

Further, the toolbar provider can, for example, already have sufficient information to register the user to participate as a respondent in a survey service, or alternatively, the user can be asked to provide the information, as specified by the survey provider (103). For example, the user might be asked to provide personal product preference, demographic, religious, and/or political information, in order to become eligible to participate in a particular survey service. The toolbar provider, in order to enhance its ability to serve its users, can choose to retain this information for its own use as well as to pass it on to the survey provider. For example, the information can be stored in a data store, or other type of data storage device, which can be accessed by the toolbar.

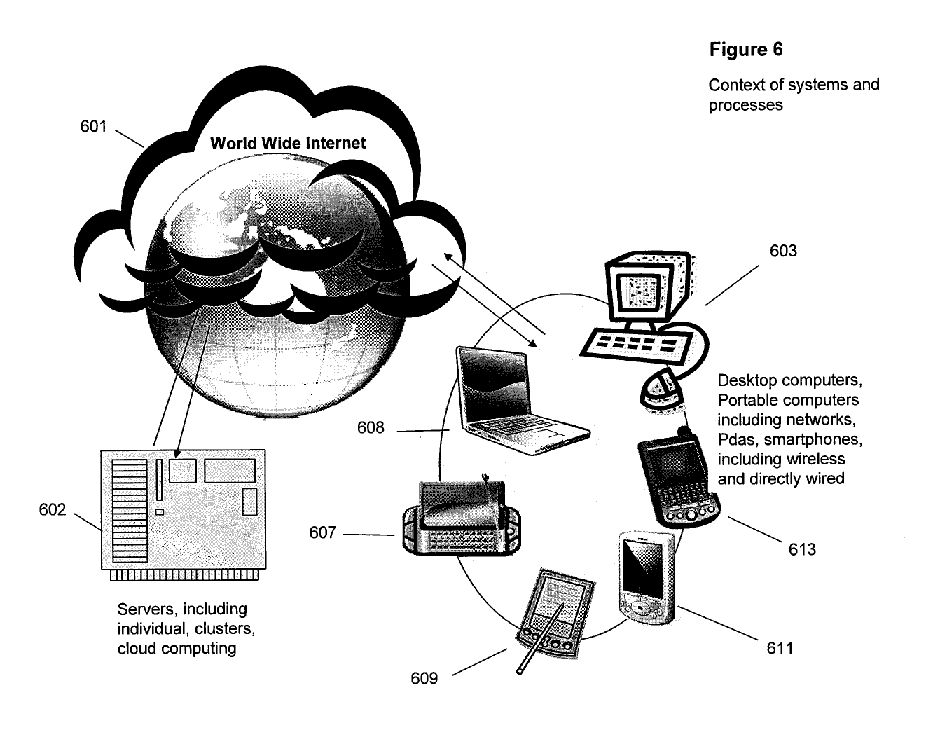

Information may be selectively provided to the survey provider in various forms, including integrated records and aggregate data. As shown in FIG. 6, a user can open a browser with which a toolbar containing the survey element has been associated, whether that browser be, for example, on a desktop computer 603, portable computer 608, PDA (personal digital assistant) 607, tablet 609, smartphone, or other such device on which a browser capable to include a toolbar runs (603), for the purposes of accessing information and services available on the world-wide web (601), often implemented and executable on a computer server, cluster of servers, server cloud, or similar such technology (602) in which the survey services are implemented and execute, and including storage of the survey data (questions, sets of questions, respondents able to take the survey, respondents already having taken the survey, time stamp information, response information, and demographic data), whether that storage be on the same device as the survey service itself or independent device.

The presentation of the toolbar can incorporate a view of at least one survey element (105), graphical or textual or audio, such that the view can alert the user to one or more services of one or more survey providers (106).

Further, the user can request (107) one of the surveys or results as made available by interacting with one of a multiplicity of survey elements presented in the toolbar.

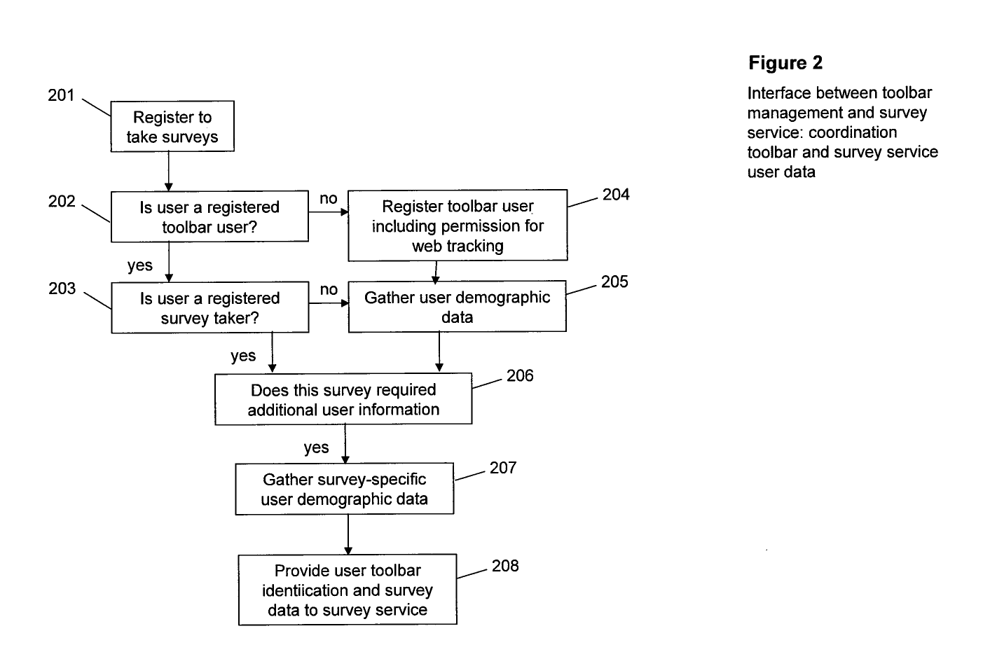

As shown in FIG. 2, a user can register to take a survey (201) by first registering as a toolbar user (202), including choosing whether to give the toolbar provider permission to track user browsing behavior (204). Toolbar registered users can then be registered as a survey service user, coordinating the identification of the survey service user as identical to that of the toolbar user (208), and additional information, for example additional demographic information, requested by the survey provider but not by the toolbar provider, can be gathered (205). Since the user is able to register with a multiplicity of survey providers, display the survey element in a multiplicity of toolbars, or add a multiplicity of toolbar survey elements to a single toolbar, it is possible that the user is already registered with the survey provider (203), so that user demographic data is already available. Individual surveys might request additional user information, for example, in order to screen survey takers according to statistical protocol (206, 207). It is possible that the registration begins with the survey provider to be coordinated with toolbar registration. The two aspects of registration may be hidden from the user.

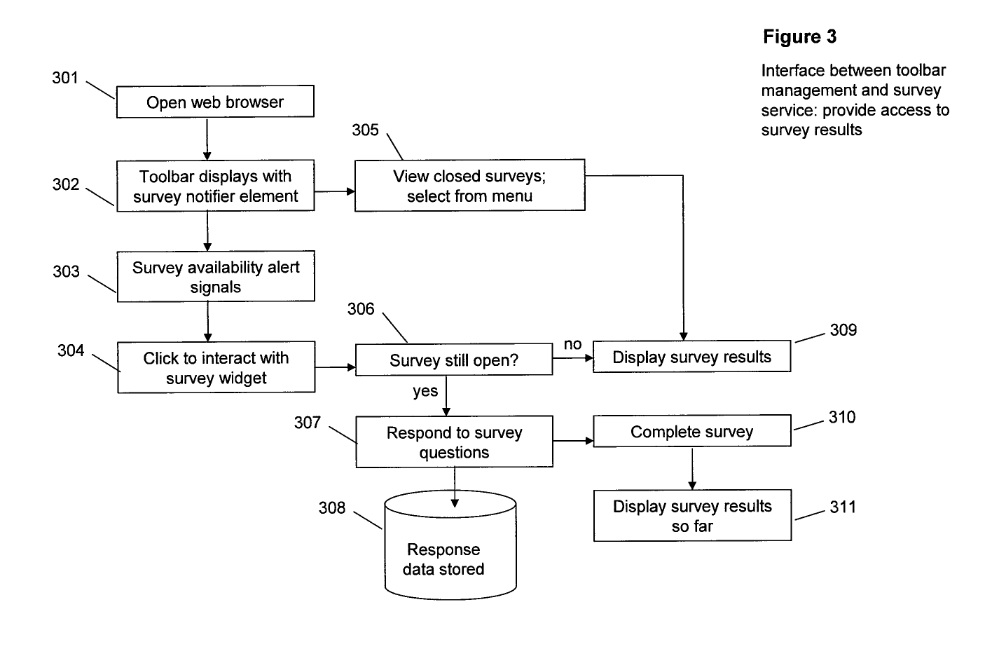

As shown in FIG. 3, on the user opening a browser associated with a toolbar (301) containing a multiplicity of survey elements (302), the toolbar can present the survey element to alert the user (303) to indicate some combination of: (a) one or more new surveys are available to the user, (b) one or more surveys remains incomplete and the user can return to complete such surveys, and (c) one or more surveys remain open for the user to return to modify responses to such surveys. On interacting with the survey element, for example, e.g., clicking on it (304), the user can access a survey that is still open for use (306), provide responses in a number of manners such as those typically offered by survey providers (307), such responses to be stored (308) as part of the data used in generating survey reports, and on completing the survey (310), depending on survey provider choice, view survey results (311). Users can also access survey results for surveys that are completed (e.g., also called closed to all users) (309).

The protocol for communication between the toolbar and survey provider may include an exchange of data, including, but not limited to, the survey response data. The toolbar service provider may collect data on user actions, such as browsing the Internet, and toolbar preferences (401) which can be shared with the survey service provider (402) to be considered (403) in the statistical analysis that can combine general demographic data, data specific to the interests of a specific survey, and survey responses (404), including user decision to change responses in case such changes are permitted for the purposes of providing the parties interested in the results of the survey with statistical analysis reports (407).

There may be a multiplicity of reports, some viewable by users as well as by the toolbar service provider and survey providers, and some viewable only by the survey providers or non-user parties interested in the survey (for example, parties who designed and commissioned the distribution of the survey). The data to be stored either by the survey provider or toolbar service provider or both (405), for example, for purposes of duplicating data for recovery in case of transmission failure. As statistical analysis is often complex and requiring time to process, caching intermediate results may be included as part of the data storage (406).

There is the additional possibility that a survey element is made available for placement in the toolbar by an organization specializing in product fulfillment services on behalf of the surveying organization, said organization having responsibility for shipping rewards or products for review to survey respondents. The toolbar service provider or survey provider collects data on which users complete a survey (501), which is provided to said fulfillment organization (502) so that the fulfillment organization can ship rewards or products to these identified users (503).

Survey service providers typically provide systems for creating surveys, specifying data to be gathered and statistical analysis to be performed, and generate requested reports.

The toolbar services identified here can also be offered when the survey element is located in the same or alternate forms on a homepage or computer desktop.

According to another exemplary embodiment of the present disclosure, the toolbar can have access to other additional information. Preferably, the toolbar can incorporate this additional information in presenting service provider applications, such as surveys, promotions, product offers, polls, and the like, to users. According to an exemplary embodiment, the additional information can include, for example, event information, news, information associated with the type of hardware and/or software on which it is running, location information, and the like. For example, the toolbar can access information associated with an event, such as the Olympics, the Super Bowl, or the World Series, and send out an alert to users associated with a service provider application associated with the event. Other exemplary embodiments of the present disclosure, the toolbar can access other information, such as location information, language, hardware or software information, and push targeted alerts associated with the various information, and/or combinations of the various information, to the user.

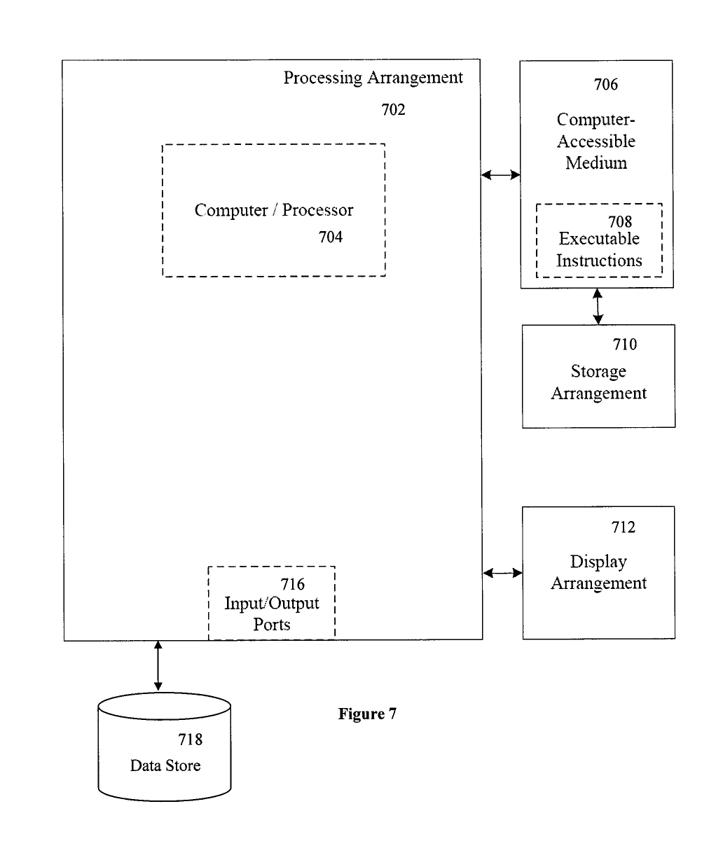

FIG. 7 shows an exemplary block diagram of an exemplary embodiment of a hardware arrangement for implementing a toolbar and service system according to an exemplary embodiment of the present disclosure. For example, exemplary procedures in accordance with the present disclosure described herein can be performed by a processing arrangement and/or a computing arrangement 702. Accordingly, processing arrangement 702 can execute instructions (e.g., code, scripts, etc.) specifying the operation of the toolbar and service provider applications. Such processing/computing arrangement 702 can be, e.g., entirely or a part of, or include, but not limited to, a computer/processor 704 that can include, e.g., one or more microprocessors, and use instructions stored on a computer-accessible medium (e.g., RAM, ROM, hard drive, or other storage device).

As shown in FIG. 7, e.g., a computer-accessible medium 706 (e.g., as described herein above, a storage device such as a hard disk, floppy disk, memory stick, CD-ROM, RAM, ROM, etc., or a collection thereof) can be provided (e.g., in communication with the processing arrangement 702). In other exemplary embodiments, these instructions can be stored in remote locations and provided to the processing arrangement via a network (e.g., wireless, the Internet, an intranet, etc.). The computer-accessible medium 706 can contain executable instructions 708 thereon, for example, that specify the details of the toolbar. In addition or alternatively, a storage arrangement 710 can be provided separately from the computer-accessible medium 706, which can provide the instructions to the processing arrangement 702 so as to configure the processing arrangement to execute certain exemplary procedures, processes and methods, as described herein above in implementing the exemplary toolbar and service provider applications.

Further, the exemplary processing arrangement 702 can be provided with or include an input/output arrangement 714, which can include, e.g., a wired network, a wireless network, the internet, an intranet, a data collection probe, a sensor, etc. As shown in FIG. 7, the exemplary processing arrangement 702 can be in communication with an exemplary display arrangement 712, which, according to certain exemplary embodiments of the present disclosure, can be a touch-screen configured for inputting information to the processing arrangement in addition to outputting information from the processing arrangement. In an exemplary embodiment, the display arrangement 712 displays the toolbar user interface. Further, the exemplary display 712 and/or a storage arrangement 710 can be used to display and/or store data in a user-accessible format and/or user-readable format.

Additionally, the information can be stored in data store 718. Further, the exemplary processing arrangement 702 can access information stored in the data store 718 and process the information in determining which alerts to push to the user. Additionally, the processing arrangement 702 can store data that it collects from the user in the data store 718.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and/or information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly incorporated herein in its entirety. All publications referenced can be incorporated herein by reference in their entireties.

What is claimed is:

1. A computer-based application stored on a non-transitory computer-readable medium including instructions thereon that are accessible by a hardware processing arrangement, wherein, when the processing arrangement executes the instructions, the processing arrangement is configured to:
provide a graphical user interface to at least one user, the graphical user interface providing for collection of user registration data;
provide at least a portion of the registration data to at least one service provider application;
access at least one data store including data associated with the at least one user;
receive an alert associated with the at least one service provider application pushed to the at least one user; and
receive a response from the at least one user associated with the alert.

2. The computer-based application of claim 1, wherein the at least one service provider application includes at least one of a survey, a promotion, a product offer, a coupon, a poll, or a service being made available to the at least one user.

3. The computer-based application of claim 1, wherein the graphical user interface includes a toolbar and is a front-end user interface for the at least one service provider application.

4. The computer-based application of claim 3, wherein at least one of the at least one service provider application or the user interface is further configured to collect data associated with the at least one user.

5. The computer-based application of claim 4, wherein the graphical user interface is further configured to update the data store to include the collected data.

6. The computer-based application of claim 1, wherein the data includes at least one of a tracking history, previous responses to alerts, demographic information, or response data associated with the at least one service provider application.

7. The computer-based application of claim 1, wherein the user interface is further configured to facilitate a registration of the at least one user with at least one of the computer-based application or the at least one service provider application using the registration data.

8. The computer-based application of claim 1, wherein the at least one service provider application includes a plurality of service provider applications associated with a plurality of providers.

9. The computer-based application of claim 1, wherein the user interface is further configured to selectively push the alert based on at least a portion of the data associated with the at least one user.

10. The computer-based application of claim 1, wherein the user interface is further configured to facilitate a participation in the at least one service provider application.

11. The computer-based application of claim 10, wherein the participation includes at least one of taking a survey, responding to a poll, accepting an offer, or agreeing to a promotion.

12. The computer-based application of claim 9, wherein the data includes at least one of a tracking history, previous responses to alerts, demographic information, or survey response data, and the selective pushing includes selectively determining the alert to be pushed.

13. A system for facilitating access to at least one service provider application, comprising:
a hardware processing arrangement; and
instructions stored on a non-transitory computer-readable medium that are accessible by the hardware processing arrangement, wherein, when the processing arrangement executes the instructions, the processing arrangement is configured to:
provide a graphical user interface to at least one user, the graphical user interface providing for collection of user registration data;
provide at least a portion of the registration data to the at least one service provider application;
access at least one data store including data associated with the at least one user;
receive an alert associated with the at least one service provider application pushed to the at least one user; and
receive a response from the at least one user associated with the alert.

14. The system of claim 13, wherein the at least one service provider application includes at least one of a survey, a promotion, a product offer, a coupon, a poll, or a service being made available to the at least one user.

15. The system of claim 13, wherein the user interface includes a toolbar and is a front-end user interface for the at least one service provider application.

16. The system of claim 13, wherein the user interface is further configured to selectively push the alert based on at least a portion of the data associated with the at least one user.

17. A method for facilitating access to at least one service provider application, comprising:
providing, using a computing arrangement, a graphical user interface to at least one user, the graphical user interface providing for collection user registration data;
providing at least a portion of the registration data to the at least one service provider application via at least one network connection;
accessing at least one data store including data associated with the at least one user via the at least one network connection;
receiving an alert associated with the at least service provider application pushed to the at least one user via the computing arrangement; and
receiving, using the computing arrangement, a response from the at least one user associated with the alert.

18. The method of claim 17, wherein the user interface includes a toolbar and is a front-end user interface for the at least one service provider application.

19. The method of claim 17, wherein the user interface is further configured to selectively push the alert based on at least a portion of the data associated with the at least one user.
